(19) United States
(12) Patent Application Publication
(10) Pub. No.: US 2015/0343625 A1
(43) Pub. Date: Dec. 3, 2015

(54) ELECTROPNEUMATIC GAS FASTENING DEVICE

(71) Applicant: ILLINOIS TOOL WORKS INC., Glenview, IL (US)

(72) Inventor: Christian RICORDI, Bourg Les Valence (FR)

(21) Appl. No.: 14/761,936

(22) PCT Filed: Dec. 31, 2013
(86) PCT No.: PCT/US2013/078470

§ 371 Date: Jul. 17, 2015

(30) Foreign Application Priority Data
Jan. 18, 2013 (FR) 1350425

(51) Int. Cl. B25C 1/08; F02B 71/04; B25D 9/10

(52) U.S. Cl. CPC B25C 1/08; B25D 9/10; F02B 71/04

(57) ABSTRACT

A gas fastening device comprising an internal combustion engine with a combustion chamber arranged between, on the one side, an upstream compression piston and, on the other side, a downstream propulsion piston, intake means to inject into the chamber a mixture of air and a fuel, means being provided to fire a mixture injected into the chamber, both pistons being mounted mobile into translation for the intake of a mixture into the chamber and, after firing a mixture, for the driving of the fastening element by the downstream propulsion piston.

The present invention relates to bedding or fastening devices, so-called gas operating ones, i.e. comprising an internal combustion engine with a combustion chamber adapted to receive a mixture of air and fuel, said fuel coming from a cartridge, and the mixture being adapted to be fired so as to propel a piston driving in turn a fastening member into a support material in order to fasten a part thereto.

Such devices are today very widespread and the Applicant has tried to solve, simultaneously, a plurality of small problems as follows:

the power increase of the devices,

the improvement of the combustion yield,

the reduction of the polluting gas being emitted,

the size reduction of the devices, and

the increase of the firing rate.

And then, they had the idea, and that is where the inventive step of the invention of the present application is, to combine the technology of the gas fastening devices and the one of the electropneumatic hammers.

An electropneumatic hammer is a device comprising an upstream activating piston and a downstream propulsion striking piston, between which one air volume is pressed by a closing up of the two pistons towards one another, so that the striking piston drives a member in the support material under the action of the compressed air detent.

Thus, the Applicant had the idea to convert an electropneumatic hammer into a gas device, with an internal combustion engine adapted to cause the driving of the downstream propulsion striking piston, replacing the electropneumatic tool air by a mixture of air and fuel adapted to be fired, by a sparking plug or by auto-ignition.

Thus, the invention relates to a gas fastening device comprising an internal combustion engine with a combustion chamber arranged between, on the one side, an upstream compression piston and, on the other side, a downstream propulsion piston, intake means to inject into the chamber a mixture of air and fuel, means being provided to fire a mixture injected into the chamber, those pistons being mounted mobile into translation for the intake of a mixture into the chamber and, after firing a mixture, for driving a fastening member by the downstream propulsion piston.

The firing means can comprise a sparking plug. But such firing means can also means the compression of even a mixture of air and fuel, such compression causing a temperature increase of the mixture which, if it goes beyond the auto-inflammation point, causes the auto-ignition.

Preferably, the upstream compression piston is arranged to be driven into translation by an eccentric.

Advantageously, the compression piston is mounted mobile in the chamber between an upstream position upstream from an intake valve for an air-fuel mixture and a downstream position upstream from the firing means.

Still advantageously, the propulsion piston is mounted mobile in the chamber between an upstream position downstream from the firing means and a downstream position downstream from an exhaust valve for the combustion gases.

It is to be noticed that the terms upstream and downstream have to be appreciated with respect to the driving direction for the fastening members by the propulsion piston.

In a first embodiment of the device according to the invention, both pistons are driven into translation so that the driving of the propulsion piston from its upstream position to its downstream position occurs after only one driving cycle of the compression piston.

In a second embodiment of the device according to the invention, both pistons are driven into translation so that the driving of the propulsion piston from its upstream position to its downstream position occurs in various steps after various driving cycles of the compression piston.

It is still to be noticed that the gas fastening device according to the present application can easily be used as a conventional electropneumatic hammer without resorting to combustion.

The invention still relates to a fastening method for a fastening member into a support material with the help of a gas fastening device, comprising an upstream compression piston and a downstream propulsion piston between which a combustion chamber extends, wherein a mixture of air and fuel is injected before compressing the mixture, and then firing it, so that, under the action of the mixture explosion, the downstream piston is driven downstream and propels the fastening member into the material.

The invention will be better comprised with the help of the following description of the fastening device referring to the accompanying drawing, wherein:

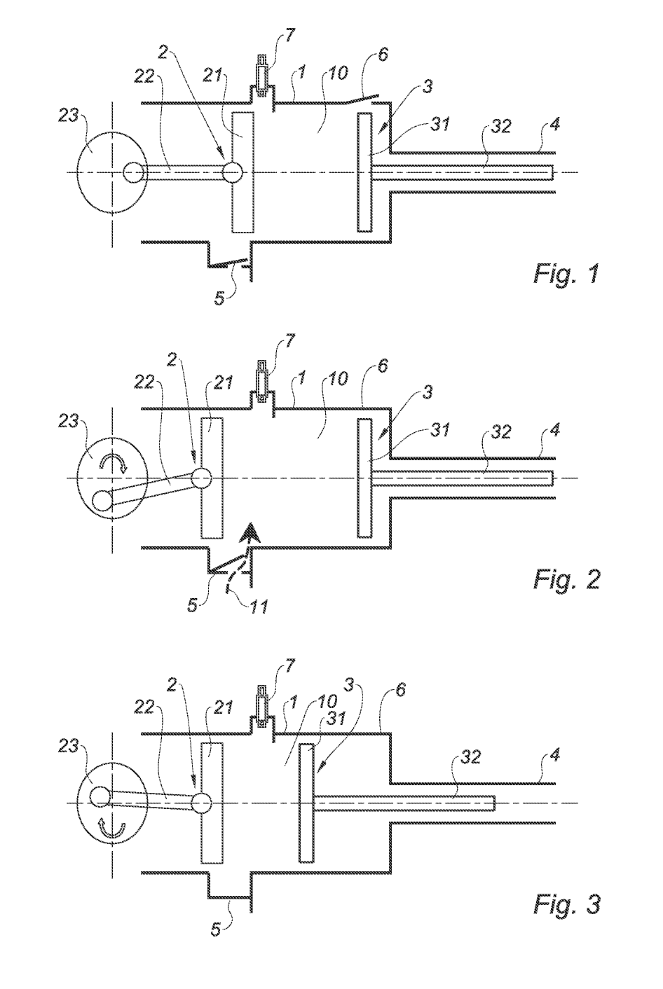

FIG. 1 is a schematic representation of the device of the invention at rest;

FIG. 2 represents the device of FIG. 1, upon the intake of a mixture of air and fuel, the exhaust valve being closed and the intake valve being open,

FIG. 3 represents the device of FIG. 1, upon the compression of the mixture of air and fuel, both valves being closed;

FIG. 4 represents the device of FIG. 1 at the end of the compression of the mixture and at the time of firing thereof, both valves being still closed; and

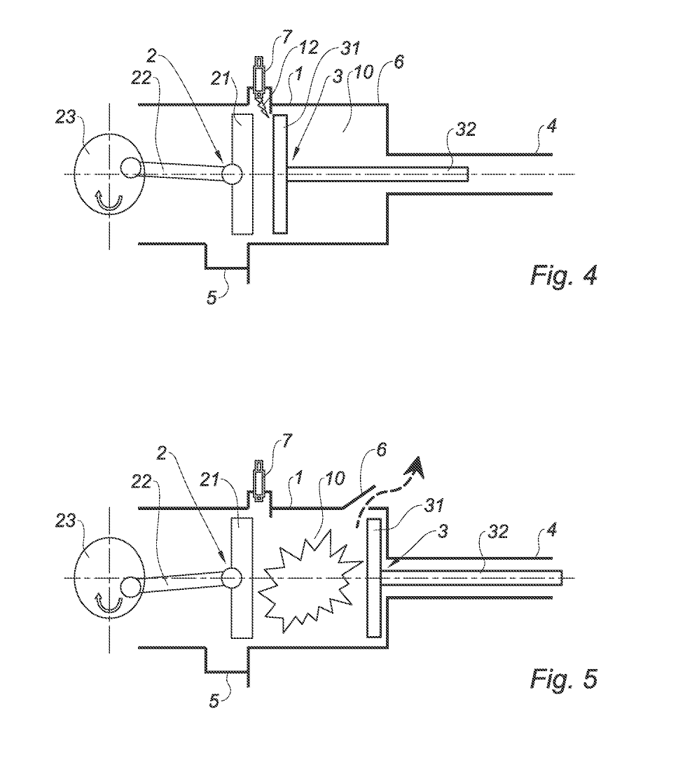

FIG. 5 represents the device of FIG. 1 after the mixture explosion and the translation downstream from the propulsion piston, the intake valve being still closed and the exhaust valve being open.

The device of the invention schematically comprises a cylinder 1, inside which two pistons 2, 3 are mounted mobile into translation. The first one, i.e. the rear or upstream one, is a compression piston 2, the other one, i.e. the front or downstream one, is a propulsion piston 3.

The compression piston 2 comprises a head 21 and a connecting rod 22 for the driving into translation of the head 2 and the sliding thereof along the wall of the cylinder 1. The connecting rod 22 is hinged to the piston head 21 and on an eccentric 23 being able to be driven into rotation by an engine, not shown.

The propulsion piston 3 comprises a head 31 and a stem 32 adapted to drive into a support material, so as to fasten a part thereto, a fastening member being previously introduced into a tip-guide, not shown, extending a gun 4 extending itself the cylinder 1 and in which the piston stem 32 slides. The head 31 of the propulsion piston 3, as well as the head of the compression piston, is adapted to slide along the wall of the cylinder 1.

The space formed between the two piston heads 21, 31 forms a combustion chamber 10 of an internal combustion engine.

The cylinder 1 comprises an intake valve 5 and an exhaust valve 6. The valve 5 is provided for entering an air-fuel mixture, the fuel coming from a cartridge arranged in a housing of the device, not shown. The valve 6 is provided for the exhaust of the combustion gases. The exhaust valve is arranged in front of the cylinder 1, in an area adjacent to the gun 4. The intake valve 5 is arranged quite upstream from the exhaust valve 6. In an area of the cylinder 1, just downstream from the area of the intake valve 5, a sparking plug 7 is fastened, dipping inside the cylinder to be able to fire a mixture of air and fuel injected into the cylinder 1 between the two piston heads 21, 31, i.e. within the combustion chamber 10.

It is to be reminded here that firing can also be carried out by auto-ignition. However, that does not allow such a flexible ignition piloting.

The head 21 of the compression piston 2 is mounted mobile within the chamber 10 between an upstream position (FIG. 3), upstream from the intake valve 5, and a downstream position (FIGS. 4, 5) upstream from the firing ignition spark 7.

The head 31 of the propulsion piston 3 is mounted mobile within the chamber 10 between an upstream position (FIG. 4) downstream from the sparking plug 7, and a downstream position (FIG. 5) downstream from the exhaust valve 6.

The terms upstream and downstream have to be appreciated with respect to the driving direction for the fastening members by the propulsion piston 3, i.e. from left to right on the figures.

After a firing step, the device is in the state represented on FIG. 1. Both valves 5, 6 are at rest, the head 21 of the compression piston 2 is practically in its most advanced downstream position, as well as the head 31 of the propulsion piston 3, however slightly moved back with respect to its most advanced downstream position.

Then, the exhaust valve 6 is closed and the head 21 of the compression piston 2 is moved backwards, i.e. upstream to inject a mixture of air and fuel through the intake valve 5, as illustrated by the arrow 11 of FIG. 2. The closing of the exhaust valve can be automatic due to the depression created by the piston 2 moving backwards.

Once the necessary quantity of the air-fuel mixture being admitted within the chamber 10, the intake valve 5 is closed and the mixture injected into the chamber 10 is compressed by moving the head 21 of the compression piston 2 downstream and the head 31 of the propulsion piston 3 upstream through a piston returning mechanism, not shown (FIG. 3).

The closing of the intake valve can be automatic due to the overpressure created by the piston 2.

The return of the propulsion piston can be automatic upon the injection and depression phase created by the piston 2 without resorting to the piston return mechanism.

When both piston heads 21, 31 are located in their extreme positions, the first one 21 downstream and the other one 31 upstream, i.e. at the end of the compression, the sparking plug 7 is activated here to fire the mixture, as illustrated by the spark 12 in FIG. 4.

Then, the explosion of the mixture (illustrated at 13 on FIG. 5) occurs, moving the head 31 of the propulsion piston 3 forwards until it comes into abutment against a dampener, not shown, the combustion gases escaping through the exhaust valve 6, being then open, as illustrated by the arrow 13.

1. A gas fastening device comprising an internal combustion engine with a combustion chamber arranged between, on the one side, an upstream compression piston and, on the other side, a downstream propulsion piston, intake means to inject into the chamber a mixture of air and fuel, means being provided to fire a mixture injected into the chamber, both pistons being mounted mobile into translation for the intake of a mixture into the chamber and, after firing a mixture, for driving the fastening member by the downstream propulsion piston.

2. The gas fastening device according to claim 1, wherein the firing means comprise a sparking plug.

3. The gas fastening device according to claim 1, wherein firing is caused by compression of an air and fuel mixture.

4. The gas fastening device according to claim 1, wherein the upstream compression piston is arranged to be driven into translation by an eccentric.

5. The gas fastening device according to claim 1, wherein the compression piston is mounted mobile in the chamber between an upstream position upstream from an intake valve for an air-fuel mixture and a downstream position upstream from the firing means.

6. The gas fastening device according to claim 1, wherein the propulsion piston is mounted mobile in the chamber between an upstream position downstream from the firing means and a downstream position downstream from an exhaust valve for the combustion gases.

7. The gas fastening device according to claim 1, wherein both pistons are driven into translation so that the driving of the propulsion piston from its upstream position to its downstream position occurs after only one driving cycle of the compression piston.

8. The gas fastening device according to claim 1, wherein both pistons are driven into translation so that the driving of the propulsion piston from its upstream position to its downstream position occurs in various steps after several driving cycles of the compression piston.

9. Use of the gas fastening device according to claim 1 as an electropneumatic hammer.

10. A fastening method for a fastening member into a support material with the help of a gas fastening device, comprising an upstream compression piston and a downstream propulsion piston, between which a combustion chamber extends, wherein a mixture of air and fuel is injected before compressing the mixture, and then firing it, so that, under the action of the mixture explosion, the downstream piston is driven out downstream and propels the fastening member into the material.
